(19) United States
(12) Patent Application Publication
(10) Pub. No.: US 2019/0285303 A1
(43) Pub. Date: Sep. 19, 2019

(54) CONTROL FOR A CLIMATE CONTROL SYSTEM

(71) Applicant: Emerson Electric Co., St. Louis, MO (US)

(72) Inventor: Abhishek Pathak, St. Louis, MO (US)

(21) Appl. No.: 16/033,273

(22) Filed: Jul. 12, 2018

Related U.S. Application Data
(60) Provisional application No. 62/644,666, filed on Mar. 19, 2018.

(51) Int. Cl. F24F 11/54; G05B 19/042; F24F 11/56; F24F 11/64; F24F 11/65

(52) U.S. Cl. CPC F24F 11/54; G05B 19/042; H04W 84/18; F24F 11/64; F24F 11/65; F24F 11/56

(57) ABSTRACT

A control for a climate control system that serves a space that is also served by a wireless communication network, includes a wireless communication system for communicating with the wireless communication network; and a processor accepting information about the devices connected to the wireless communication network received via the wireless communication system and executing a climate control program that controls the HVAC system based upon information about the devices connected to the wireless communication network.

### FIELD

This disclosure relates to climate control systems, and in particular to automated controls for climate control systems.

### BACKGROUND

This section provides background information related to the present disclosure which is not necessarily prior art.

Automated controls for climate control systems have been around since the invention of the thermostat, but progress continues to be made to automate the operation of climate control systems and eliminate the need for manual intervention.

One type of control that has been developed employs geofencing, the application of GPS technology to determine whether one or more occupants is present in a space to control the HVAC system service the space accordingly. However, there are issues with such applications of geofencing due to inaccuracies in location and delays in updating location, as well as battery usage of the geolocated devices.

### SUMMARY

This section provides a general summary of the disclosure, and is not a comprehensive disclosure of its full scope or all of its features.

Generally, embodiments of this disclosure provide a control for a climate control system that serves a space that is also served by a wireless communication network. A preferred embodiment of such a control comprises a wireless communication system for communicating with the wireless communication network. The control further includes a processor that accepts information about the devices connected to the wireless communication network received via the wireless communication system and executes a climate control program that controls the HVAC system based at least in part upon information about the devices connected to the wireless communication network. Typically, the wireless communication network will include at least one router, and the processor communicates with the at least one router via the wireless communication system, and can determine what devices are connected to the wireless communication network.

Information about the number and/or identity of the devices connected to the wireless network can be used by the control to determine whether or not occupants are present in the space, and control the HVAC accordingly. Moreover, when the devices are associated with particular individuals, information about the identity of the devices connected to the wireless network can be used by the control to determine the whether or not particular individuals are present in the space, and control the HVAC accordingly.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram showing a preferred embodiment of control in accordance with the principles of this invention, as it interacts with an HVAC and wireless network serving a space;

FIG. 2 is a flow chart of one possible process implemented by the control for determining the absence of one or more particular individuals in a climate controlled space; and

FIG. 3 is a flow chart showing the operation of the control upon determination of an occupant.

Corresponding reference numerals indicate corresponding parts throughout the several views of the drawings.

### DETAILED DESCRIPTION

Example embodiments will now be described more fully with reference to the accompanying drawings.

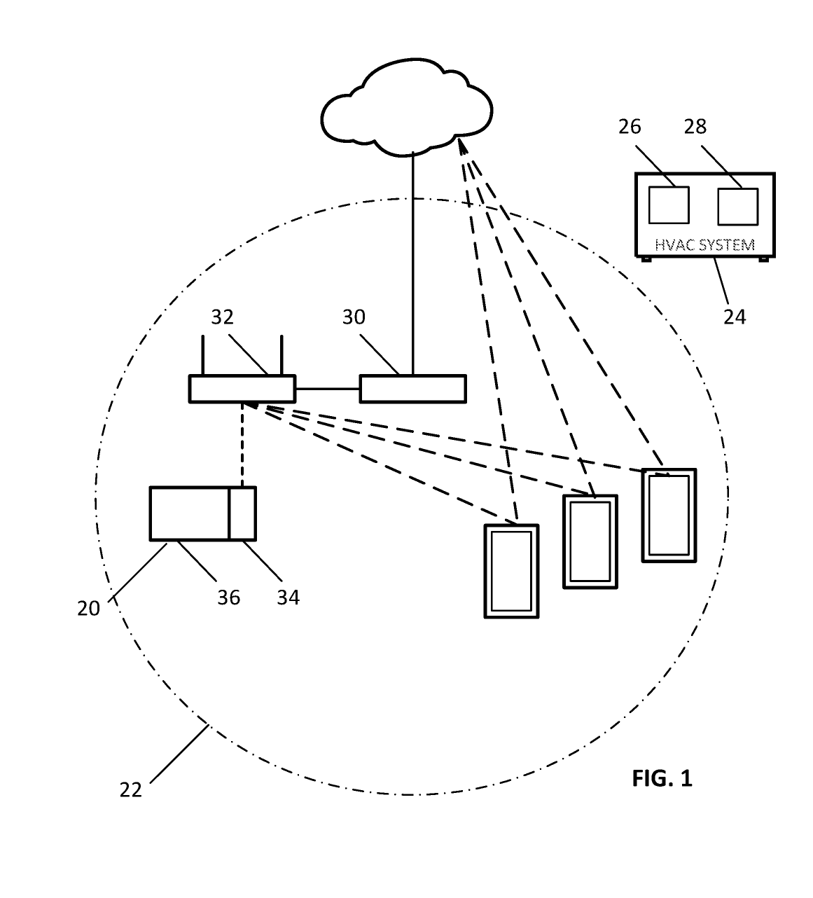

A preferred embodiment of a control according to the principles of this invention is indicated generally as 20 in FIG. 1. The control 20 is intended to operate in a space 22 that is a served by a climate control system 24 as well as a wireless communication network 26. The areas of operation of climate control system 24 and wireless communication network 26 preferably overlap at least substantially, but may or may not overlap entirely.

The climate control system 24 preferably includes at least one of, and preferably both of, at least one heater 26 and at least one air conditioner 28. The climate control system may include other climate control equipment as well.

The wireless communication network preferably includes a modem 30 or other device for connection to an external communication network, such as the internet. The wireless communication network preferably also includes a hub device, such as a router 32, for wirelessly connecting to devices in the space 22.

The control 20 comprises a wireless communication system 34 for communicating with the wireless communication network 26, and in particular the router 32 of the wireless network. The control 20 further includes a processor 36 that is programmed to obtain information about the devices that are connected to the wireless communication network 26 received via the wireless communication system 34 and execute a climate control program that controls the HVAC system 24 based at least in part upon information about the devices connected to the wireless communication network.

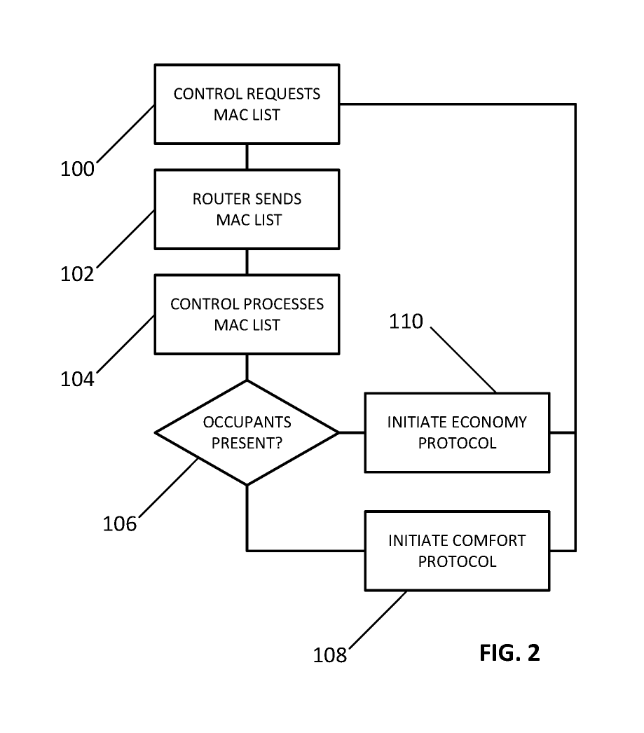

FIG. 2 shows a process the processor 36 of control 20 can use to obtain information about the devices connected to the wireless communication network 26. Information about the number and/or identity of the devices connected to the wireless network can be used by the control to determine whether or not occupants are present in the space. The processor can be programmed to use this information to control the climate control system 24 based upon the number of, and/or the identities of, the occupants of the space.

As shown in FIG. 2, at 100 the processor 36, through wireless communication system 34, can periodically interrogate the router 32 to obtain a list of the media access control address (MAC address) of devices connected to the router. At 102 the router 32 sends the MAC list to the control. At 104 the control processes the information received from the router. In some instances, this information may simply be an indication of the number of devices connected to the wireless communication network 26, and from this the processor can determine whether there are occupants in the space. At 106 the control determines whether the space S is occupied. Depending on the network, the number of devices connected to the wireless communication network 26 may directly represent the number of occupants. In other networks, there may be other non-occupant devices on the network, for example printers, appliances, etc. By periodically interrogating the router 32, the processor 36 can develop a database of connections versus time, from which it can determine the number of base line devices, or the number of base line devices for a given time and/or day. The processor 36 can then determine the number of occupants in the space by subtracting the current number of connected devices from the appropriate baselines.

In some embodiments the generalizing system identifies specific devices, such as by using the MAC ID of the connected device and/or the static allocated IP addresses etc. There can also be a mechanism where a secured code between the device and the controller is used to authenticate presence of device within the wireless network by using the code as the identity of the device. The identities of specific devices can be used to determine the presence or absence of persons, or specific persons in the space.

The processor can then initiate the appropriate control program to control the climate control system 22 based at least in part upon the current occupation of the space. For example if at 106 it is determined that the space is unoccupied, then at 110 the processor can operate the climate control system under an energy savings protocol to increase the set point temperature in warm weather, or decrease the set point temperature in cold weather, to reduce energy consumption by the climate control system. Similarly, if at 106 it is determined that the space is occupied, then at 108 the processor can operate the climate control system to deactivate an energy savings protocol, and return to a comfort protocol to decrease the set point temperature in warm weather, or increase the set point temperature in cold weather, to reduce energy consumption by the climate control system.

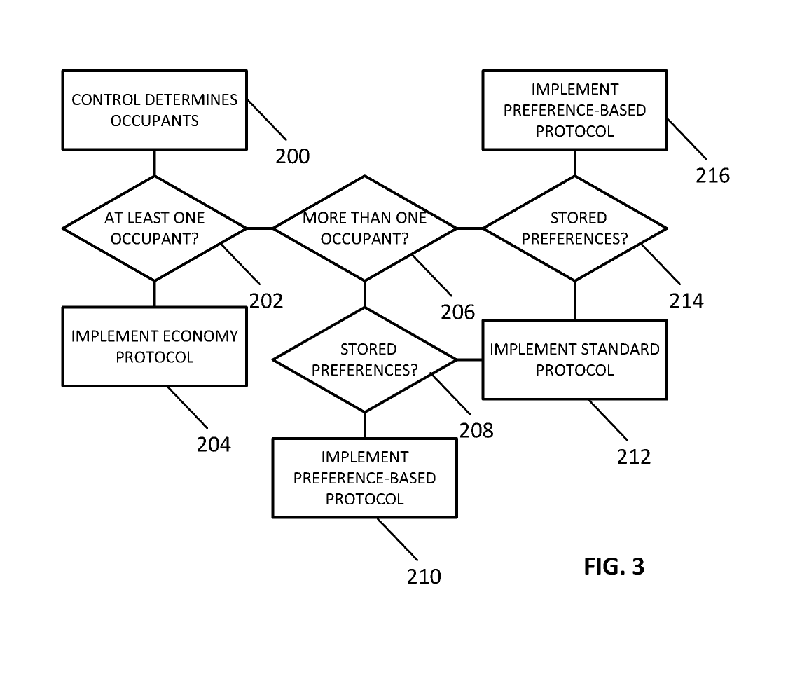

One possible method for the control to select the appropriate control program after determining the occupancy of the space S is shown In FIG. 3. At 200 the control determines the occupants of the space. If at 202 the control determines that there is not at least one occupant in the space, then at 204 the control selects and implements an economy protocol based upon factory defaults or user selections based up the day, date, and/or time.

If at 202 the control determines there is at least one occupant, then at 206 the control determines whether there is more than one occupant. If there is just one occupant then at 208 the control determines whether there are stored user preferences for the space generally, or for the particular occupant. If at 208 there are stored user preferences then at 210 the control implements an HVAC control program based upon those preferences. If there are not stored user preferences, then at 212 the control implements a standard protocol for the time, date, and/or season.

If at 206 there is more than one occupant, then at 214 the control determines whether there are stored user preferences for the space generally, or for the particular occupants. If at 214 there are stored user preferences then at 216 the control implements an HVAC control program based upon those preferences. If there are not stored user preferences, then at 212 the control implements a standard HVAC program for the time, date, and/or season.

In some instances, the information from the router 32 may include information about the type of device connected to wireless communication network, for example the information may include whether the connected device is a cell phone. By periodically interrogating the router 32, the processor 36 can develop a database of connections versus time, from which it can determine the number of permanent cell phones and the number of transient cell phones, or the typical number of cell phones for a given time and or day. The processor 36 can then determine the number of occupants in the space by counting the number of connected cell phones, or if there are some cellular devices that are substantially continuously connected to the network, subtracting the number of continuously connected devices from the current number of connected cellular devices. As described above, if it is determined that the space is unoccupied, the processor can operate the climate control system under an energy savings protocol to increase the set point temperature in warm weather, or decrease the set point temperature in cold weather, to reduce energy consumption by the climate control system. Similarly, if it is determined that the space is occupied, the processor can operate the climate control system to deactivate an energy savings protocol, and return to a comfort protocol to decrease the set point temperature in warm weather, or increase the set point temperature in cold weather, to improve the comfort of the space, although increasing energy consumption by the climate control system.

In some instances, the information from the router 32 may include information about the identities of the devices connected to wireless communication network. The devices of the various occupants of the space can be registered, for example with the controller, or via an application connected with a server (for example in the cloud). The processor can compare with the identities of the currently connected devices with the identities of the devices registered by particular occupants, and thereby determine the identities of the occupants. As part of the registration process, or otherwise, the occupants can store set point preferences or schedules of set point preferences, and in some cases other climate control preferences. The processor can use the identities of the occupants and stored information about user preferences to control the client control system.

For example, with the space unoccupied and operating in an energy saving climate control protocol, if the processor detects the presence of a first user, the processor can implement a generic comfort protocol, or if the particular occupant's climate control preferences are stored and accessible to the processor, the processor can implement a comfort protocol based upon the occupant's climate control preferences. If the processor detects a second occupant, the processor can switch to a generic protocol to accommodate multiple users, or the processor can implement a protocol based upon the preferences of the detected occupants, for example operating at the highest set point of the preferences of the detected users, the lowest set point of the preferences of the detected users, or the average set point of the preferences of the detected users.

While occupants can register their preferences or otherwise associate their preferences with their device ID, the control can be provided with the capability of detecting the user's preferences by identification situations where a particular use is alone in the space and recording the user's preferences.

In some embodiments, the control may implement control programs based upon the identities of the devices connected to the wireless communication network, while in other embodiments, the control may implement control programs based in part upon the identities of the devices connected to the wireless communication network, and take into account other factors such as the absence of known devices on the wireless network, the presence of unknown devices on the wireless network, time of year, time of day, or other factors. In other embodiments the control can implement control programs based upon the identities of the devices not connected to the wireless communication network, or based in part upon the identities of the devices connected to the wireless communication network, and take into account other factors such as the presence of know devices on the wireless network, the presence of unknown devices on the wireless network, time of year, time of day, or other factors. The control can also implement control programs upon the detection of a new connection to the wireless network, or a disconnection from the wireless network, whether by a known device or an unknown device.

Based on the information about devices connected to and/or not connected to the wireless network, (including new connections and disconnections) the control according operates one of a plurality of HVAC control programs. These control programs can include factory established programs and/or user defined programs. For example the processor may be implementing a program that controls the HVAC according to time, but the processor interrupts this program to implement a new program based upon information about the devices connected to the wireless communication network. For example, detecting the departure of one or more occupants from the space or the arrival of one or more occupants to the space.

The control preferably periodically obtains a list of devices connected to the router to determine whether (or not) a particular device is connected to the wireless communication system. The control may wait for a certain number of cycles to be sure that occupants are present or absent from the space, so that transient signal losses or disconnections do not unnecessarily interfere with the normal control of the HVAC system. The control then implements the appropriate control program for the detected occupants of the space.

The control is most conveniently implemented as a thermostat, such as the Sensi Wi-Fi smart thermostat. A thermostat is already connected to and controls the HVAC system and has wireless communication, a memory, and a processer for carrying out the methods of this invention. Because such thermostats are wi-fi enabled, some of the storage and/or some of the processing can be done remotely, for example on a server in the cloud.

The thermostat (or other embodiment of the control) typically includes a display screen and real or virtual buttons that can facilitate the registering of wireless devices such as smart phones and tablets. Alternatively these devices can be registered to a server using an app running on the smart phone or table, and the registration information can be used by the server, or downloaded from the server to the thermostat or other control, where the information can be stored in local memory.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A control for a climate control system that serves a space that is also served by a wireless communication network, the control comprising
a wireless communication system for communicating with the wireless communication network; and
a processor accepting information about the devices connected to the wireless communication network received via the wireless communication system and executing a climate control program that controls the HVAC system based upon information about the devices connected to the wireless communication network.

2. The control according to claim 1 wherein the wireless communication network includes at least one router, and wherein the processor communicates with the at least one router via the wireless communication system.

3. The control according to claim 2 wherein the information about the devices connected to the wireless communication network includes at least one of (a) the identities of the devices connected to the wireless communication network; and (b) the identities of the devices not connected to the wireless communication network.

4. The control according to claim 3 wherein the program controls the HVAC system based at least in part upon the identities of the devices connected to the wireless communication network.

5. The control according to claim 3 wherein the program controls the HVAC system based at least in part upon the identities of the devices not connected to the wireless communication network.

6. The control according to claim 3 wherein the processor operates one of a plurality of HVAC control programs based at least in part upon the identities of the devices connected to the wireless communication network.

7. The control according to claim 3 wherein the processor operates one of a plurality of HVAC control programs based at least in part upon the identities of the devices not connected to the wireless communication network.

8. The control according to claim 3 wherein the processor controls the HVAC system based upon the detection of the connection of a device to the wireless communication network.

9. The control according to claim 3 wherein the processor controls the HVAC system based upon the detection of the disconnection a device from the wireless communication network.

10. The control according to claim 3 wherein the processor executes a program that controls the HVAC according to time, and wherein the processor interrupts the operation of the program based upon information about the devices connected to the wireless communication network.

11. The control according to claim 2 wherein the processor periodically obtains a list of devices connected to the router and determines whether a particular device is connected to the wireless communication system.

12. The control according to claim 2 wherein the control periodically obtains a list of devices connected to the router and determines whether a particular device is not connected to the wireless communication system.

13. The control according to claim 2 wherein the control periodically obtains a list of devices connected to the router and determines and executes one of a plurality of predetermined climate control programs based upon the identities of the devices connected to the router.

14. The control according to claim 2 wherein the control periodically obtains a list of devices connected to the router and determines and executes one of a plurality of predetermined climate control programs based upon the identities of devices not connected to the router.

15. The control according to claim 1 wherein the control is a thermostat.

16. A control for a climate control system that serves a space that is also served by a wireless communication network having at least one router, the control comprising:
a wireless communication system for communicating with the at least one router;
a processor that receives, via the wireless communication system, information about the devices connected to the wireless communication network, and executes a climate control program that controls the HVAC system based upon information about the devices connected to the router.

17. The control according to claim 16 further comprising a memory, and a processor programmed to register wireless devices that connect to the wireless communication network, and to store information about the registered devices in the memory.

18. The control according to claim 17 wherein the processor is programmed to periodically obtain, via the communication system, a list of devices connected to the wireless communication network and to compare this list to the information about the registered devices stored in the memory, to determine network connection status information comprising at least one of (a) which registered devices are connected to the network and (b) which registered devices are not connected to the network, the processor further programmed to execute a climate control program based at least in part on the determined network connection status information.

19. The control according to claim 18 wherein the processor determines network connection status information based upon comparisons with lists of connected devices obtained over a predetermined number of periods.

20. The control according to claim 18 wherein the processor determines network connection status information based upon comparisons with multiple lists obtained over a predetermined period of time.

21. The control according to claim 18 wherein the program controls the HVAC system based at least in part upon the identities of the devices connected to the wireless communication network.

22. The control according to claim 18 wherein the program controls the HVAC system based at least in part upon the identities of the devices not connected to the wireless communication network.

23. The control according to claim 18 wherein the processor operates one of a plurality of HVAC control programs based at least in part upon the identities of the devices connected to the wireless communication network.

24. The control according to claim 18 wherein the processor operates one of a plurality of HVAC control programs based at least in part upon the identities of the devices not connected to the wireless communication network.

25. The control according to claim 18 wherein the processor controls the HVAC system based upon the detection of the connection of a device to the wireless communication network.

26. The control according to claim 18 wherein the processor controls the HVAC system based upon the detection of the disconnection a device from the wireless communication network.

27. The control according to claim 18 wherein the processor executes a program that controls the HVAC according to time, and wherein the processor interrupts the operation of the program based upon information about the devices connected to the wireless communication network.

28. The control according to claim 18 wherein the processor periodically obtains a list of devices connected to the router and determines whether a particular device is connected to the wireless communication system.

29. The control according to claim 18 wherein the control periodically obtains a list of devices connected to the router and determines whether a particular device is not connected to the wireless communication system.

30. The control according to claim 18 wherein the control periodically obtains a list of devices connected to the router and determines and executes one of a plurality of predetermined climate control programs based upon the identities of the devices connected to the router.

31. The control according to claim 18 wherein the control periodically obtains a list of devices connected to the router and determines and executes one of a plurality of predetermined climate control programs based upon the identities of devices not connected to the router.

32. The control according to claim 16 wherein the control is a thermostat.
